(19) United States
(12) Patent Application Publication
(10) Pub. No.: US 2011/0319142 A1
(43) Pub. Date: Dec. 29, 2011

(54) Helmet communication device

(76) Inventors: Jian-Ming Chen, Taipei City (TW); Mei-Ling Kuo, Taipei City (TW)

(21) Appl. No.: 12/078,541

(22) Filed: Apr. 1, 2008

(51) Int. Cl. H04W 88/00

(52) U.S. Cl. 455/569.1

(57) ABSTRACT

A helmet communication device is composed primarily of a first communication device, a second communication device and a switching circuit device, such that when a motorcycle driver is driving the motorcycle, the driver can choose to use the first communication device to answer a cellular phone with a wired or blue-tooth technology, or to converse with a back seat passenger through the second communication device, by a control of the switching circuit device, so as to improve driving safety and to improve convenience in answering the cellular phone or dialoging with the back seat passenger.

### BACKGROUND OF THE INVENTION

a) Field of the Invention

The present invention relates to a helmet communication device, and more particularly to a two-in-one communication device wherein a first communication device is provided in a helmet to connect with a cellular phone, and a back seat of a motorcycle can be connected for conversation through a switching communication device.

b) Description of the Prior Art

In an existing life, a cellular phone has become a necessity of living, as it is convenient in using and carrying. However, a lot of users will usually ignore driving safety upon using the cellular phone. For example, when the user is riding a motorcycle with one hand, while the other hand holding the cellular phone for conversation, he or she will not be able to drive carefully; therefore, an unfortunate traffic accident may be resulted, or a traffic regulation may be even broken. Therefore, a lot of hand-free tools have been developed on markets, and the most popular one is to connect an earphone with the cellular phone, so as to form a hand-free communication device.

Nevertheless, in using this kind of communication device which uses a wiring to connect a microphone and a one-ear earphone, as a motorcycle driver should first put the earphone into an ear and then wear the helmet for communication, it will be inconvenient and the driver will feel very uncomfortable due to that the earphone is stuffed in the ear and also abutted by the helmet. In a mean time, an extended signal wire is directly exposed to fly with wind, which will be easily hooked by an external object to affect the driving safety. On the other hand, the earphone can easily drop out, communication quality can be inferior, and it will be inconvenient to wear the helmet.

Moreover, as the motorcycle driver should wear the helmet upon driving the motorcycle, if a back seat is taken by another passenger, then voice of conversation will be blocked by the helmet and air flow upon talking when driving the motorcycle. Therefore, the voice will not be clearly transmitted to that passenger, thereby resulting in a plenty of inconvenience and also affecting the driving safety. Accordingly, it is actually necessary to re-develop and improve the aforementioned conventional hand-free headphone device used for the motorcycle.

### SUMMARY OF THE INVENTION

The primary object of the present invention is to provide a helmet communication device which is a two-in-one communication device allowing a back seat passenger of a motorcycle to be connected with a cellular phone for conversation. The device can be affixed conveniently on all kinds of motorcycle helmets, enabling a driver to safely answer the cellular phone while driving or to converse with the back seat passenger, thereby increasing practicability of the helmet and driving safety.

Another object of the present invention is to provide a helmet communication device which is a two-in-one communication device allowing a back seat passenger of a motorcycle to be connected with a cellular phone for conversation. The device can be affixed conveniently on all kinds of merchant motorcycle helmets, enabling that product to be used broadly, thereby increasing practicability and an economic value.

Accordingly, a helmet communication device of the present invention includes primarily a first communication device, a second communication device and a switching circuit device. Upon assembling for use, the first communication device, the second communication device and the switching circuit device are installed respectively at proper positions inside or outside a merchant helmet, and then the first communication device, the second communication device, the switching circuit device and the cellular phone are electrically connected respectively, through each signal transmission wire and signal-power wire. When a circuit change-over switch in the switching circuit device is set at an OFF position, the first communication device is connected with the cellular phone, and electricity needed for a voice processing circuit of the first communication device is provided directly by the cellular phone, such that the cellular phone can be answered. On the contrary, when the switching circuit device is set at an ON position, the voice processing circuit of the first communication device is conducted electrically with a battery power circuit. At this time, the electricity needed for the voice processing circuit is provided by the battery power circuit, allowing the first communication device to connect with the second communication device for conversing mutually.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows an exploded view of the present invention.

FIG. 2 shows a perspective view of the present invention after being assembled.

FIG. 3 shows a flow diagram of receiving a cellular phone of the present invention.

FIG. 4 shows a block diagram of operations of a first communication device, a second communication and a switching circuit device of the present invention.

FIG. 5 shows a schematic view of a structure of the present invention using a signal wire to answer a cellular phone.

FIG. 6 shows a schematic view of a structure of the present invention which answers a cellular phone with a blue tooth technology.

### DETAILED DESCRIPTION OF THE PREFERRED EMBODIMENTS

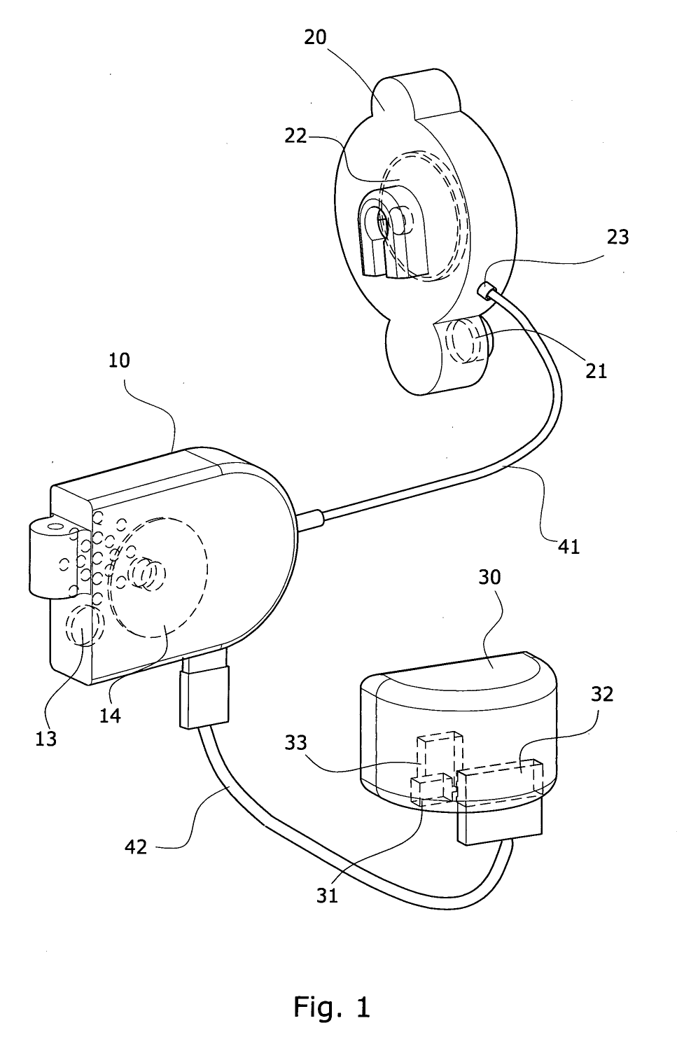

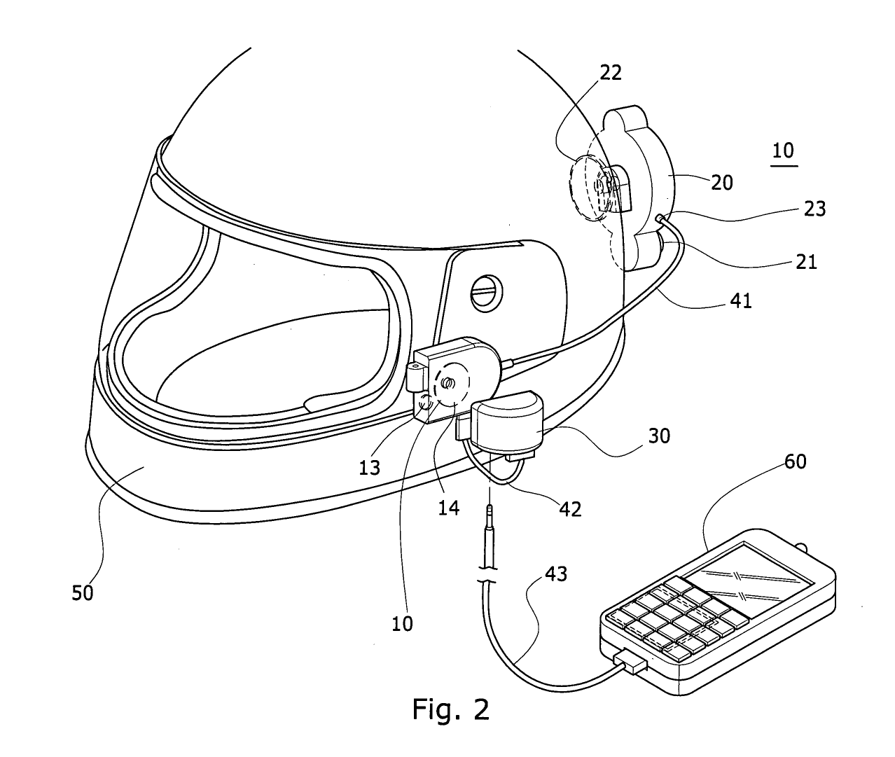

Referring to FIG. 1 and FIG. 2, a helmet communication device of the present invention comprises primarily a first communication device 10, a second communication device 20 and a switching circuit device 30.

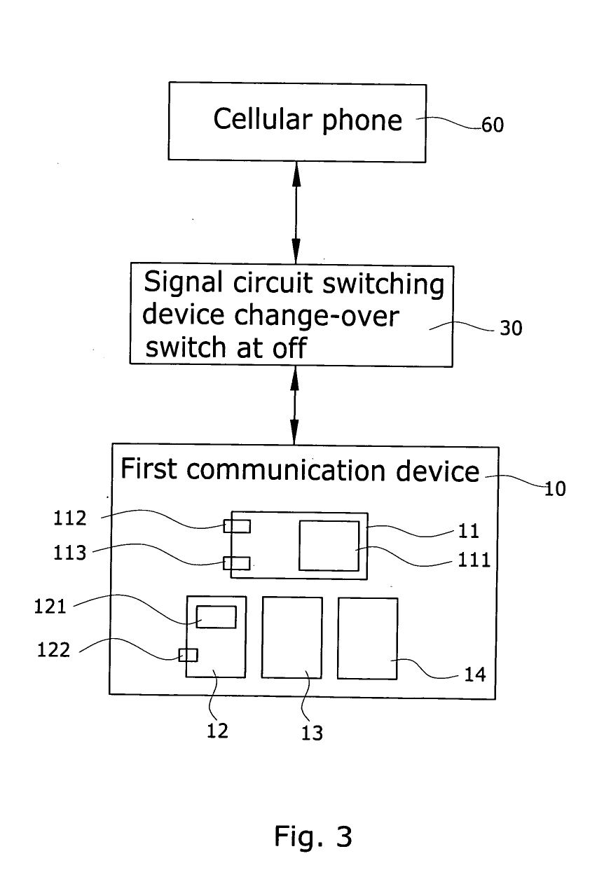

Referring to FIGS. 1 to 3, the first communication device 10 is fixed at an exterior side of a helmet 50, and an interior of a housing of the first communication device 10 includes a voice processing circuit 11, a battery power circuit 12, a microphone 13 and a speaker 14, with the voice processing circuit 11 being provided with a voice processing chip 111, a signal input end and a signal output end of the voice processing chip 111 being connected respectively with two connection ports 112, 113, the microphone 13 being conducted with the voice processing chip 111 through the signal input connection port 112, the speaker 14 being conducted with the voice processing chip 111 through the signal output connection port 113, the battery power circuit 12 being assembled by connecting a battery set 121 and a connection socket 122, and the microphone 13 and the speaker 14 being provided inside the helmet 50.

The second communication device 20 is installed removably (a sucking disk or a double-side tape can be used for fixing) on an outer wall close to a rear side of the helmet 50, and an interior of a housing of the second communication device 20 is provided with a microphone 21, a speaker 22 and a connection socket 23, with the microphone 21 and the speaker 22 being electrically connected with the signal input connection port 112 and the signal output connection port 113 of the first connection device 10 through a signal transmission wire 41 that is connected on the connection socket 23.

The switching circuit device 30 is fixed on an outer wall at a side of the helmet 50, including a circuit change-over switch 31 and two connection sockets 32, 33, with the connection sockets 32, 33 (as shown in FIG. 2) being electrically connected with the first communication device 10 and a cellular phone 60 through a signal-power wire 42 and a signal transmission wire 43 respectively, and the circuit change-over switch 31 of the switching circuit device 30 controlling an ON or OFF of the battery power circuit 12 in the first communication device 10, such that when the circuit change-over switch 31 is turned on (ON), the battery power circuit 12 will be electrically connected with the voice processing circuit 11.

Referring to FIG. 1 and FIG. 2, it shows a schematic view of a preferred embodiment of the present invention. When a driver rides a motorcycle, he or she can wear this helmet 50 and insert the signal transmission wire 43 of the cellular phone 60 into the corresponding connection socket 33 in the switching circuit device 30 which then uses the connection wire 42 to forward to the first communication device 10 provided in the helmet 50, enabling the cellular phone 60 to be electrically connected with the first communication device 10 for conversing directly.

Furthermore, as the microphone 13 of the first communication device 10 is provided on an inner wall of the helmet 50 at a position close to the ear, wind will not blow directly to the microphone 13 when driving in a high speed; and interference of a wind shear noise can be prevented upon receiving a voice. On the other hand, the speaker 14 is provided on an inner wall of the helmet 50 at a position close to the ear and a power amplifier can be also provided on a voice playing circuit; therefore, the conversation can be clearer. In addition, as the second communication device 20 can be hung on the outer wall at the rear side of the driver's helmet 50 and can be taken down at any time, a function that a back seat passenger can communicate with the front seat driver is provided. Moreover, the back seat passenger can take down the second communication device to hold for communication or to hang in the helmet at any time, so as to increase clearness of conversation.

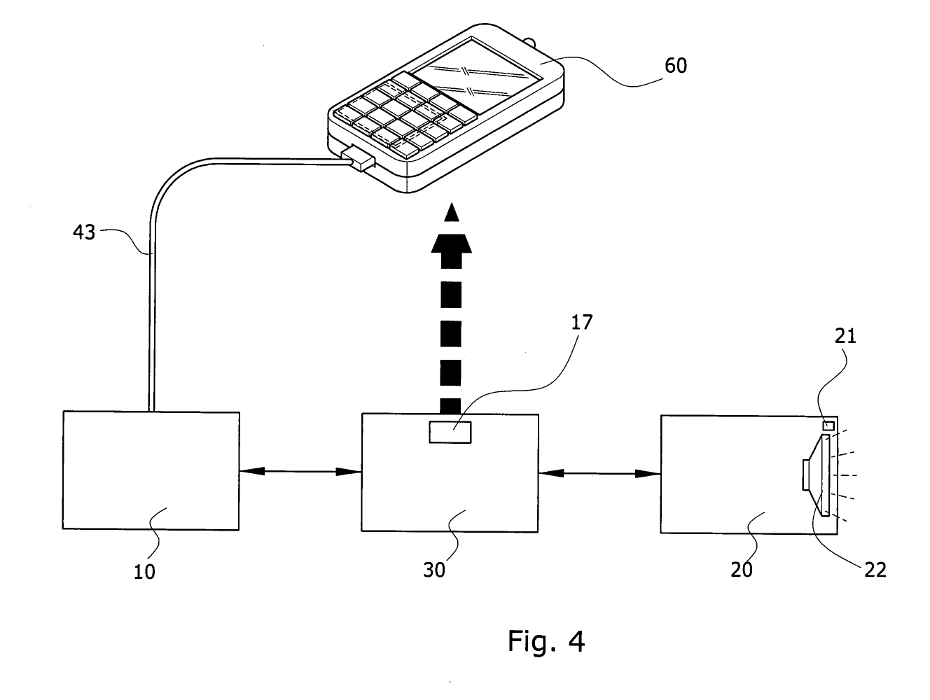

Referring to FIGS. 1 to 4, wherein FIG. 4 shows an operational flow diagram of the present invention when all parts have been electrically connected, when the circuit change-over switch 31 of the switching circuit device 30 is turned off (OFF), a blue tooth or wired communication can be conducted between the first communication device 10 and the cellular phone 60 through the switching circuit device 30, and electricity needed for the voice processing circuit 11 of the first communication device 10 is provided directly by the cellular phone 60, so as to achieve an object of answering the cellular phone. Thus, the driver can answer the phone without holding the phone when an incoming call is sent from the cellular phone, thereby improving driving safety. On the contrary, when the circuit change-over switch 31 of the switching circuit device 30 is turned on (ON), the voice processing circuit 11 of the first communication device 10 will be conducted with the battery power circuit 12 to form an electrical connection. At this time, the battery power circuit 12 will provide the voice processing circuit 11 with the needed electricity, allowing the first communication device 10 and the second communication device 20 to be connected for conversation, so as to achieve an object that the driver can converse with the back seat passenger. Accordingly, the conversation between the driver and the passenger can be transmitted to each other clearly, without having a condition that it is not easy to communicate, due to the block of the helmet. This function not only enables the driver and the passenger to converse freely when the motorcycle is traveling, but also reduces a possible danger resulted when the driver needs to turn his or her head continuously for conversation.

On the other hand, according to the structures described in FIG. 2, upon implementing, the signal transmission wire 41 and the signal-power wire 42 can be embedded in advance in a structure of the helmet 50, or can transmit conversation signals wirelessly. In addition, the first communication device 10, the second communication device 20 and the switching circuit device 30 can be integrally formed on the structure of the helmet 50, so as to provide a prettier appearance, and to further improve practicability and an economic value.

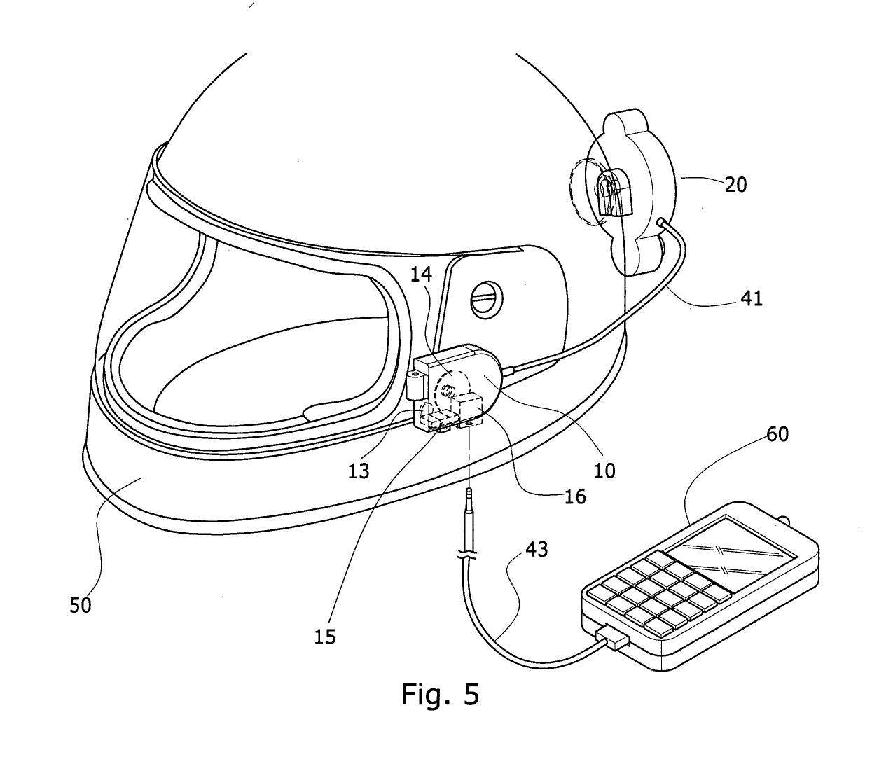

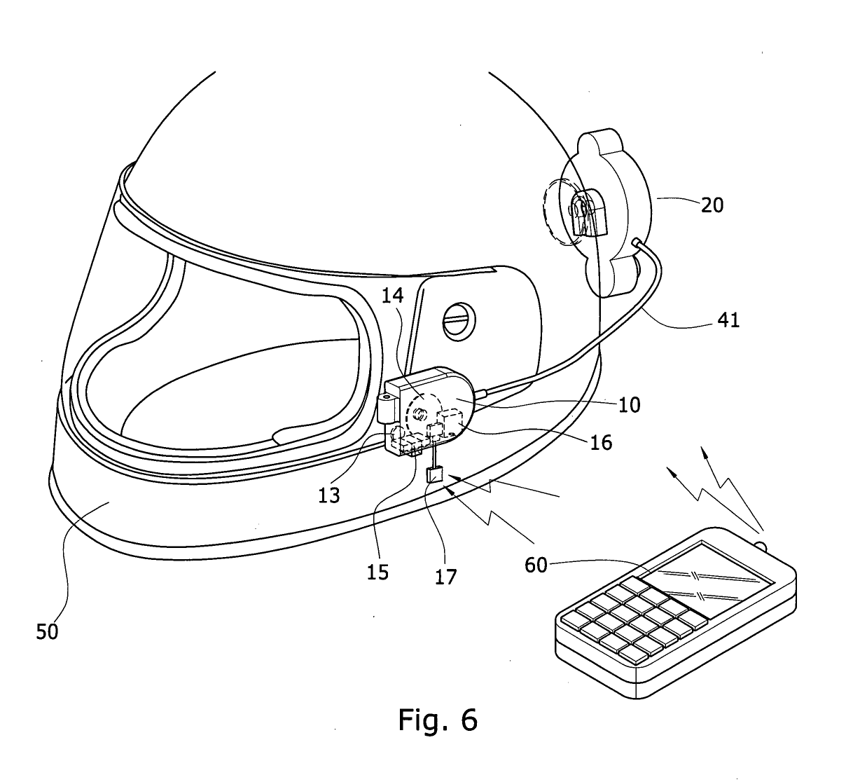

Referring to FIG. 5, upon implementing the structures of the present invention, the first communication device 10 and the switching circuit device 30 are integrally formed as one unit; that is, the housing of the first communication device 10 is provided additionally with a circuit change-over switch 15 and a connection socket 16, the ON or OFF of the first communication device 10 is controlled by the circuit change-over switch 15 and the connection socket 16 is directly connected with the signal transmission wire 43 of the cellular phone 60 to accomplish the electrical connection. Upon using the present invention, when the circuit change-over switch 15 is turned off (OFF), the first communication device 10 can dialog with the cellular phone 60. On the other hand, when the circuit change-over switch 15 is turned on (ON), the first communication device 10 can dialog with the second communication device 20. At this time, the cellular phone 60 cannot be answered. Moreover, as shown in an embodiment of FIG. 6, the connection socket 16 of the first communication device 10 in the previous embodiment is added with a wireless receiver 17 (such as a blue-tooth receiver). Therefore, the present invention can use the wireless transmission method to connect the cellular phone 60 for use.

Accordingly, the present invention uses the switching circuit device to forward to the first communication device in the helmet, such that the cellular phone carried by the driver can be connected directly. On the other hand, by the switching of the switching circuit device, the battery power circuit in the first communication device is controlled, so as to provide the second communication device at the rear side of the helmet with the electricity needed for dialoging, such that the first communication device can be connected with the second communication device, thereby achieving the function that the driver can dialog with the back seat passenger, while effectively keeping the driving safety.

After implementing the helmet communication device of the present invention, plural advantages are produced:
1. The present invention can be conveniently installed on any merchant helmet for use without being limited to manufacturers and types of the helmets, and thus can be manufactured and sold independently, thereby achieving functions of being used broadly and reducing cost of manufacturing and stocks.
2. The conversation between the driver and the back seat passenger will not be blocked by the helmet, so as to prevent the shortcoming that the communication will be difficult when driving the motorcycle.
3. When the driver is conversing with the back seat passenger, he or she will not need to turn his or her head to allow the voices to be clearly transmitted to the rear side, and the passenger can also clearly transmit the voices to the driver through the second communication device, thereby effectively reducing the danger resulted from that the driver turns the head for conversation.
4. A cellular phone can be answered without using the hand, so as to assure the driving safety.

Accordingly, after implementing the helmet communication device of the present invention, the driver can safely answer the phone or communicate with the back seat passenger when driving the motorcycle, thereby improving applicability of the helmet.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A helmet communication device comprising a first communication device, a second communication device and a switching circuit device, wherein the first communication device is fixed at an exterior side of a helmet, and includes a voice processing circuit, a battery power circuit, a microphone and a speaker, with the voice processing circuit being provided with a voice processing chip, a signal input end and a signal output end of the voice processing chip being connected respectively with two connection ports, the microphone being conducted with the voice processing chip through the signal input connection port, the speaker being conducted with the voice processing chip through the signal output connection port, and the battery power circuit being assembled by connecting a battery set with a connection socket; the second communication device is removably provided on an outer wall close to a rear side of the helmet, and an interior of a housing of the second communication device includes a microphone, a speaker and a connection socket, with the microphone and the speaker being electrically connected with the signal input connection port and the signal output connection port in the first communication device through a signal transmission wire that is connected on the connection socket; and the switching circuit device is fixed on an outer wall at a side of the helmet, including a circuit change-over switch and two connection sockets, with the two connection sockets being electrically connected with the first communication device and a cellular phone respectively, through a signal-power wire and a signal transmission wire, and an on or off of the battery power circuit in the first communication device being controlled by the circuit change-over switch of the switching circuit device, such that when the battery power circuit is turned on, the battery power circuit is electrically connected with the voice processing circuit.

2. The helmet communication device according to claim 1, wherein the signal transmission wire and the signal-power wire used by the first communication device, the second communication device and the switching circuit device are embedded in the helmet.

3. The helmet communication device according to claim 1, wherein the switching circuit device is replaced by a circuit change-over switch and a connection socket, and is provided on the housing of the first communication device.

4. The helmet communication device according to claim 1, wherein the first communication device is connected with a wireless receiver.

5. The helmet communication device according to claim 1, wherein the microphone and the speaker of the first communication device are provided at an inner side of the helmet.
